(19) United States
(12) Patent Application Publication
(10) Pub. No.: US 2014/0311089 A1
(43) Pub. Date: Oct. 23, 2014

(54) BOTTLE CAPPING CHUCKS

(71) Applicants: Michael P. Scott, Midland, MI (US); Larry D. Dotson, Midland, MI (US)

(72) Inventors: Michael P. Scott, Midland, MI (US); Larry D. Dotson, Midland, MI (US)

(21) Appl. No.: 13/865,256

(22) Filed: Apr. 18, 2013

(51) Int. Cl. B67B 3/20

(52) U.S. Cl. CPC B67B 3/20
USPC 53/331.5

(57) ABSTRACT

The capping industry has many variations in each cap that is placed on containers. It is very critical that a capping chuck have the ability to adapt quickly and easily to each and every cap that is available. The present invention uses the flexibility in its construction to grasp all variations to the caps without the need for expensive and time consuming shut downs. The present capping chuck meets these ever expanding changes within the industry.

### BACKGROUND OF THE INVENTION

Capping chucks are not new to the art. The need for quickly interchangeable chucks is crucial to industries that use plastics in bottle processing. A major need is to adapt to the changing needs of the industry. Many prior art chucks exist in an attempt to meet the ever changing needs of the industry. The industry uses a wide variety of different size and shaped caps. Most have only aesthetic value. Such a response is U.S. Pat. No. 8,220,225 issued to Zemlin, on Jul. 17, 2012, entitled, “Capping Chuck Assembly”.

The Zemlin patent uses a system that is dependent on ball bearings to facilitate movement of angled teeth to grip irregular size caps. The bottling industry is known to bottle soft drinks. The main drawback with the Zemlin chuck is that the sugar from the soft drinks accumulates on the Zemlin chuck impeding operation and the chuck has to be cleaned or replaced frequently.

### THE INVENTION

The present invention is a capping chuck assembly for bottle capping machines. The assembly is comprised of a housing that has an operative end and a threaded end. This housing has a central opening therethrough that has a centered mid-point. The operative end comprises a hub that has a plurality of evenly spaced-apart notches therein. Each notch has resident therein an independently radially movable chuck segment.

The chuck segment has a front surface that has a plurality of vertical pins positioned thereon for gripping a bottle cap. The hub has a horizontally grooved outside surface. Each chuck segment has a horizontally grooved back surface aligning with the grooves in the hub and configured for receiving an O-ring therein. Each chuck segment has a first end surface that is biased to allow the chuck segment to be move radially away from the centered mid-point of the central opening.

Each chuck segment has a second end surface that is biased to allow the chuck segment to be retained in a respective notch. A common rubber O-ring is located in the hub grooves and the chuck segment grooves.

### BRIEF DESCRIPTION OF THE DRAWINGS

FIG. 1 is a cross sectional view of the capping chuck assembly taken through line B-B of FIG. 2.

FIG. 2 is a full view of the capping end of the capping chuck.

FIG. 3 is a cross sectional view of the capping chuck assembly taken through line A-A of FIG. 2.

FIG. 4 is a full view of the capping chuck assembly from the side.

FIG. 5 is a view in perspective of the capping chuck assembly showing the bottom opening or the operative end 6.

FIG. 6 is a partial sectional view of the capping chuck taken through line C-C of FIG. 2.

FIG. 7 is a full bottom view of the capping chuck.

FIG. 8 is a full view of FIG. 3 without the teeth.

FIG. 9A is a view in perspective of the capping chuck without teeth showing the bottom opening.

FIG. 9B is a full view of an enlarged portion of a segment of FIG. 9A to showing the absences of teeth.

FIG. 10 is a full view of a segment of a chuck showing enlarged teeth.

FIG. 11 is an expanded full bottom view of the various tooth segments.

### DETAILED DESCRIPTION OF THE DRAWINGS

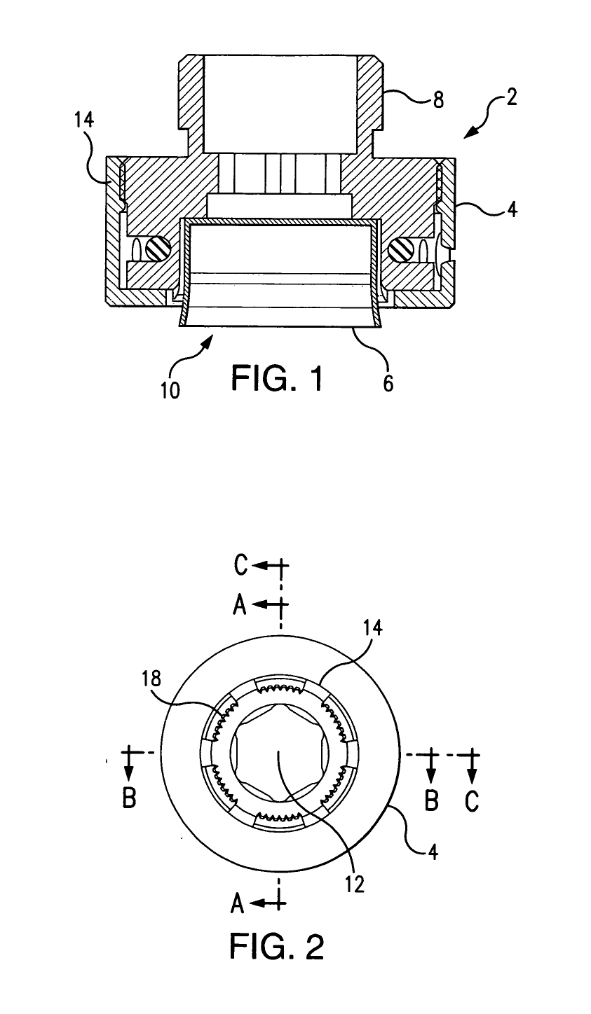

FIG. 1 is a sectional view of line B-B of the capping chuck assembly 2 of FIG. 2 without the movable teeth 18. The threaded end 8 is near the top and is capable of quickly attaching or detaching onto a capping machine. The housing 4 contains within it the operative end 6 (capping end). The operative end 6 is also where the hub 14 can be observed. Also shown is the central opening that passes through the entire length of the capping chuck 2.

FIG. 2 shows the capping end 6. It is shown in this view where the center midpoint 12 resides. The housing 4 contains the hub 14 and the independent radially movable chuck segments 18 with teeth 20 are located.

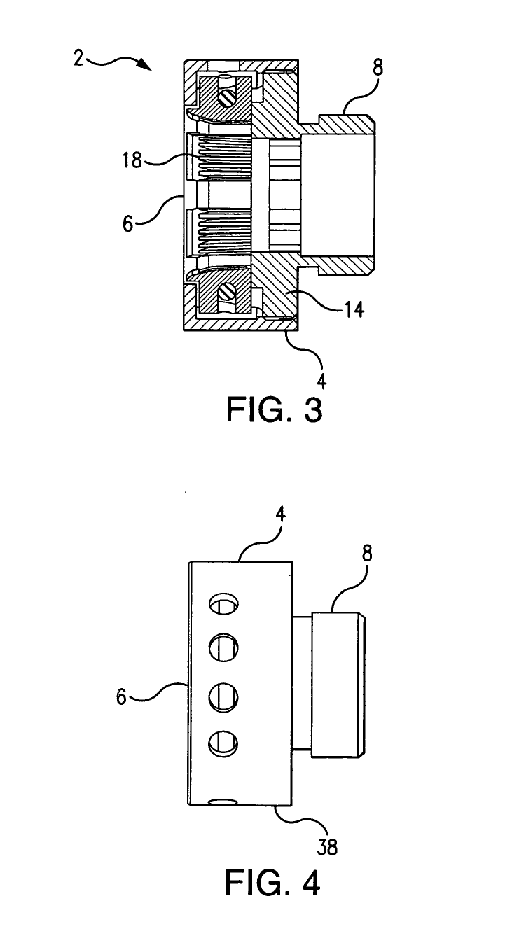

FIG. 3 shows a sectional view of line A-A of the capping chuck assembly 2 of FIG. 2. The hub 14 shows the threaded end 8 and the operations end 6. Also shown within the housing 4 are the hub 14 and the teeth 18.

FIG. 4 shows the capping chuck assembly 2 from the side. The housing 4 has an outside surface 38.

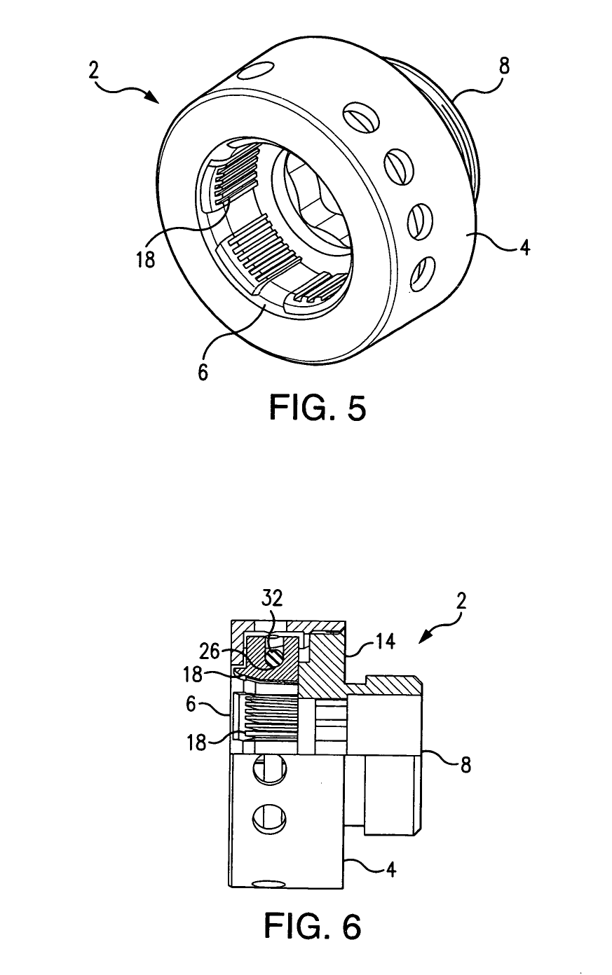

FIG. 5 shows the capping chuck assembly 2. This Figure shows the housing 4, the threaded end 8 and the operative end 6. Inside of the operative end 6 are the teeth 18. The capping chuck 2 attaches to the capping machine at the threaded end 8. The operative end 6 is where the caps are secured and torqued onto the bottles. The cap inserts into the operative end 6, the teeth 18 grab the cap and tighten it to the bottle. The teeth 18 are supported in the housing 4 by the hub 14 and an O ring (not shown in this Figure).

It has been discovered that the flexibility of the teeth 18 within the housing 4 allow the capper to accommodate any varying shape and size caps. This is a huge utility over all prior art cappers, in that, cappers have to be changed to fit different caps. The industry uses a variety of sized and shaped caps mostly for aesthetic purposes. Each time there is a change in the type of cap used the capper has to be changed out. This slows or stops production, wasting money. The bearingless design allows for longer use with less fouling and reduction in loss of production time, saving time and money.

FIG. 6 is a partial sectional view line C-C of the capping chuck 2. This figure shows the relationship between the teeth 18, hub 14 and the O ring 32. The O ring 32 holds the teeth 18 equidistant with the hub 14 in place, but allows them to expand to accept or accommodate the varying sizes and shapes of the caps. Also shown is the groove 26 in the teeth 18 and hub 14 for the O ring to flexibly retain the teeth 18. It also shows the relationship between the housing 4, the threaded end 8 and the operative end 6.

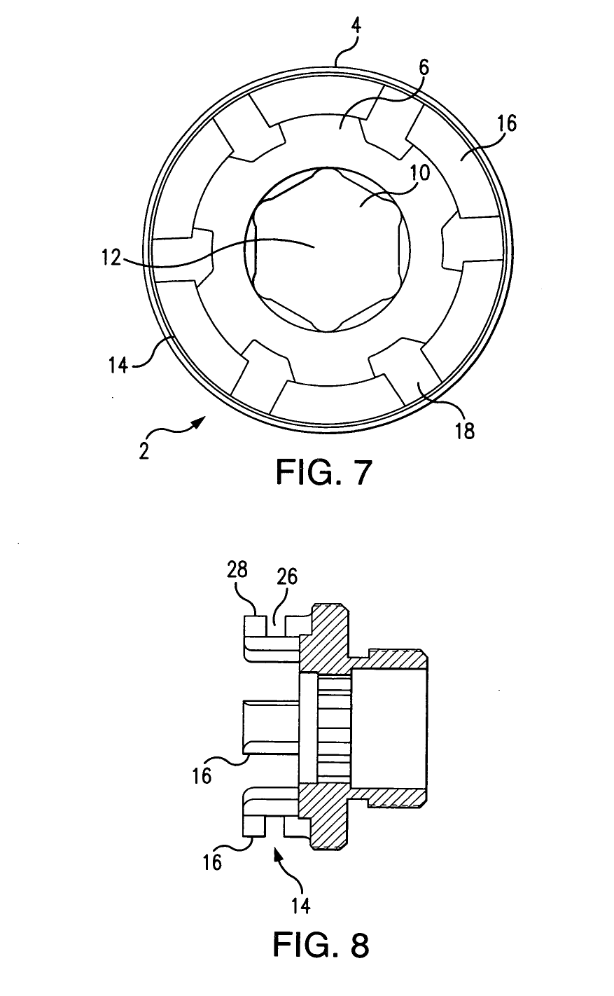

FIG. 7 shows the end of the capping chuck 2. This view shows the housing 4 attachment area in relationship to the hub 14. It shows the relationship of the evenly spaced notches 16 in cooperation with the hub 14 and teeth 18 of the operative end 6. Also it is clear that the central opening 10 has a central midpoint 12.

FIG. 8 shows the capping chuck 2 without teeth 18. Here the hub 14 shows the evenly spaced notches 16 and the groove 26 that accommodate the O ring 32. Also shown here is the back surface 28 of each evenly spaced notch 16.

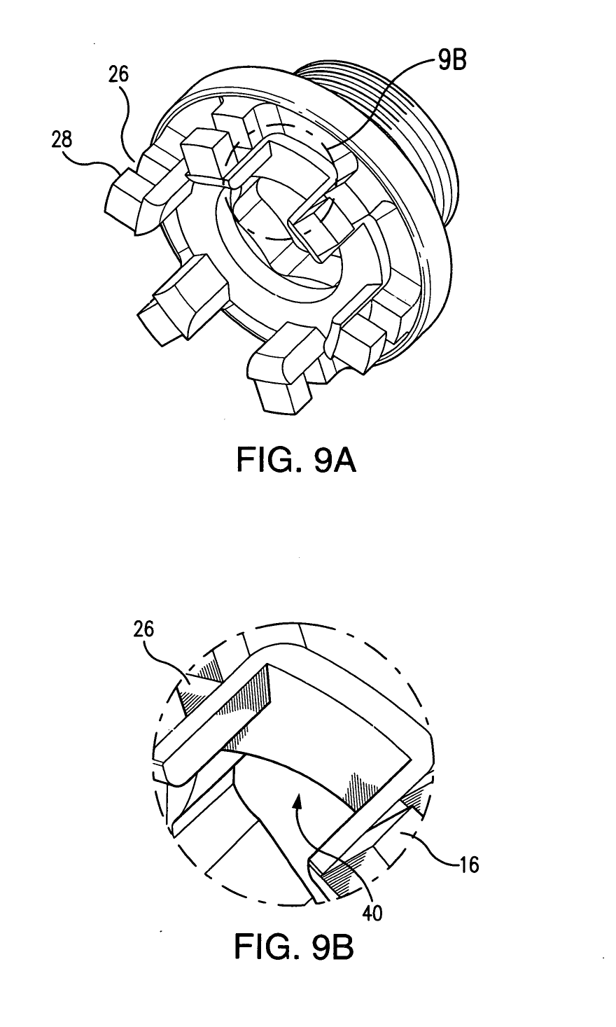

FIG. 9A shows the capping chuck without moveable teeth from the side. Shown is the back surface 28 of the evenly spaced notches 16 and the groove 26 of the evenly spaced notches that together form the hub 14.

FIG. 9B shows the capping chuck 2 and hub 14 in an expanded view without a moveable tooth 18. This is the position 40 where each tooth 18 is flexibly placed within the hub 14 and between the evenly spaced notches 16 and retained by the O ring 32.

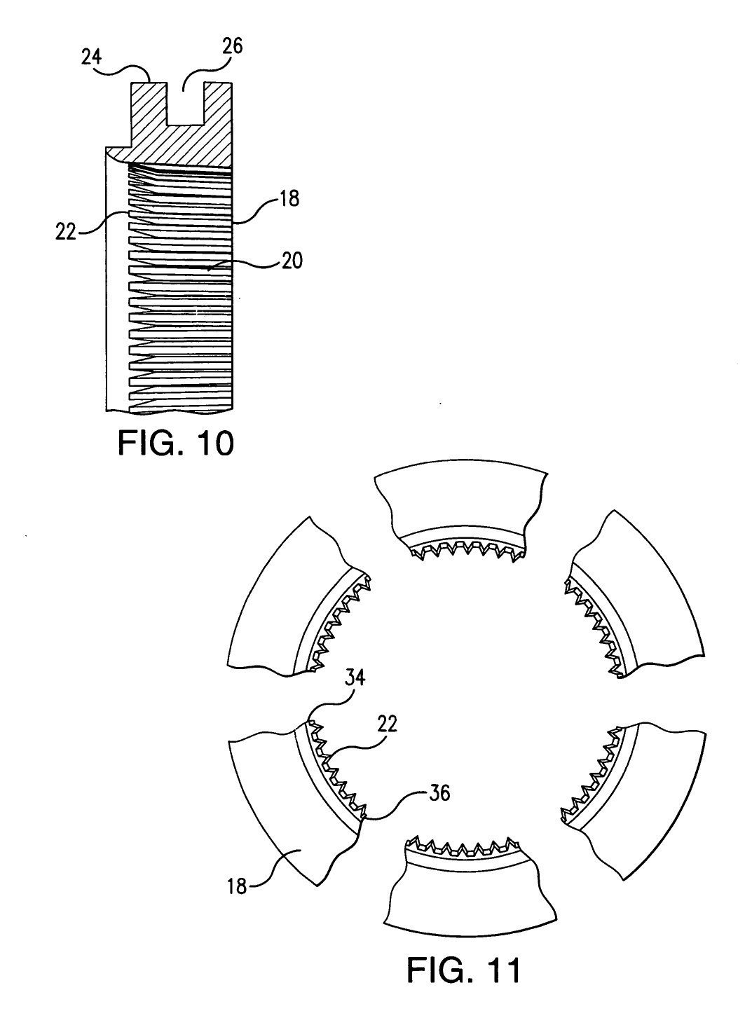

FIG. 10 shows the toothed edge 22 of a moveable tooth 18. Also shown is the front surface 20 of 18 and the outside surface 24 of the tooth 18. The groove 26 for the O ring 32 is also shown.

FIG. 11 shows the teeth segments 18. Each tooth segment has vertical pins 22 that combine to form teeth 18. Each tooth segment 18 has a first end surface 34 and an end surface 36. This Figure shows the angle of each vertical pin 22 that allows the tooth segments 18 to make contact with the cap and grip it during the capping process thus driving the cap in the desired direction and tightening the cap onto the bottle.

What is claimed is:

1. A capping chuck assembly, said assembly comprising:
a. a housing having an operative end and a threaded end, said housing having a central opening therethrough having a centered mid-point;
b. said operative end comprising a hub, having a plurality of evenly spaced-apart notches therein, each said notch having resident therein an independently radially movable chuck segment, said chuck segment having a front surface having a plurality of vertical pins positioned thereon for gripping a bottle cap;
c. said hub having a horizontally grooved outside surface;
d. each said chuck segment having a horizontally grooved back surface aligning with said grooves in said hub and configured for receiving an O-ring therein;
e. each said chuck segment having a first end surface that is biased to allow said chuck segment to be move radially away from said centered mid-point of said central opening;
f. each said chuck segment having a second end surface that is biased to allow said chuck segment to be retained in a respective notch;
g. a common rubber O-ring located in said hub grooves and said chuck segment grooves.
